(19) United States
(12) Patent Application Publication
(10) Pub. No.: US 2016/0159603 A1
(43) Pub. Date: Jun. 9, 2016

(54) ADHESIVE TAPE DISPENSER CAPABLE OF CUTTING AN ADHESIVE TAPE AT A UNIFORM LENGTH

(71) Applicant: Yu-Chun HUANG, Taichung City (TW)

(72) Inventor: Yu-Chun HUANG, Taichung City (TW)

(21) Appl. No.: 14/610,506

(22) Filed: Jan. 30, 2015

(30) Foreign Application Priority Data
Dec. 4, 2014 (TW) 103142122

(51) Int. Cl. B65H 35/00; B26D 1/36

(52) U.S. Cl. CPC B65H 35/0026; B26D 1/365

(57) ABSTRACT

An adhesive tape dispenser capable of cutting an adhesive tape at a uniform length includes a suction cup for fastening to a tabletop, an operating handle operable to rotate a rotating wheel in pulling out an adhesive tape of a tape roll on the tape roller and to drive a gear set in rotating a cutter holder so that cutter blades at the cutter holder are moved into one of a series of cutting slots in the rotating wheel to cut the adhesive tape into multiple adhesive tape segments of the same lengths, and thus, the tape cutting efficiency is greatly improved. Further, the design of the suction cup enhances the operational stability of the adhesive tape dispenser.

### BACKGROUND OF THE INVENTION

1. Field of the Invention

The present invention relates to adhesive tape dispensing technology, and more particularly to an adhesive tape dispenser that is capable of cutting an adhesive tape at a uniform length.

2. Description of the Related Art

Adhesive tape dispenser is a tool widely used today for shearing an adhesive tape for adhering things. When using an adhesive tape dispenser, the user can simply use the eyes to check whether or not the length of the adhesive tape been pulled out is sufficient. Sometimes, the length of the adhesive tape been pulled out can be too long, other times, the length of the adhesive tape been pulled out can be too short. So, it not only will lead to a waste of adhesive tape, but also bring some degree of distress to the user.

In order to solve the aforesaid problem, Korean Patent 10-2009-0117280 teaches the use of a rotating wheel to pull an adhesive tape out of a tape roller at predetermined length, and a cutter blade to cut the adhesive tape at the rotating wheel at a uniform length through a reciprocation motion. However, this design simply uses one single cutter blade for cutting the adhesive tape. In consequence, the adhesive tape dispensing efficiency of this design is not optimal.

### SUMMARY OF THE INVENTION

The present invention has been accomplished under the circumstances in view. It is the main object of the present invention to provide an adhesive tape dispenser, which is capable of cutting a uniform length of adhesive tape, improving operational efficiency and increasing operational stability.

To achieve this and other objects of the present invention, an adhesive tape dispenser of the invention comprises a housing, a first tape roller, a rotating wheel, an operating handle, a gear set, a first cutter unit, and a positioning unit. The first tape roller is rotatably mounted in one end of the housing for supporting a tape roll. The rotating wheel comprises a rotating shaft rotatably mounted in an opposite end of the housing, a plurality of supporting arms radially and equiangularly connected to the periphery of the rotating shaft, and a cutting slot defined between each two adjacent supporting arms. The operating handle comprises a handle grip and a handle shaft. The handle shaft has one end thereof rotatably inserted through one lateral side of the housing and connected to the rotating shaft of the rotating wheel, and an opposite end thereof disposed outside the housing and connected with the handle grip. The gear set comprises a drive gear coupled to the rotating shaft of the rotating wheel, and at least one transmission gear rotatably mounted inside the housing and meshed with the drive gear. The first cutter unit comprises a first cutter holder, a driven gear, and a plurality of first cutter blades. The first cutter holder is rotatably mounted inside the housing. The driven gear is fixedly mounted on one end of the first cutter holder and meshed with the at least one transmission gear. The first cutter blades are equiangularly arranged around the periphery of the first cutter holder, and respectively insertable into one cutting slot of the rotating wheel. The positioning unit comprises a suction cup located in a bottom side of the housing.

With the above design, before operating the adhesive tape dispenser, the housing is positively positioned on a tabletop by means of the suction cup to enhance the operation stability. At the beginning of the adhesive tape dispensing operation, operate the operating handle to rotate the rotating wheel, causing the rotating wheel to pull out the adhesive tape of the tape roll. At the same time, the gear set is driven to synchronously rotate the first cutter holder, moving the first cutter blades into one respective cutting slot of the rotating wheel to cut the adhesive tape into multiple adhesive tape segments of the same length, and thus the efficiency of the adhesive tape dispensing operation is greatly enhanced.

Preferably, the positioning unit further comprises a positioning seat, an operating rod and a press bar. The positioning seat is mounted in the bottom side of the housing, defining therein an accommodation chamber that accommodates the suction cup. The operating rod is disposed inside the housing, comprising a cam portion. The press bar has a top end thereof pivotally connected to the cam portion of the operating rod, and an opposing bottom end thereof inserted into the accommodation chamber and fixedly connected with the suction cup. Thus, the press bar can be driven by the operating rod to move the suction cup. By means of the suction cup, the positioning seat can be positively and steadily positioned in a selected location, and then the housing can be fastened to the top side of the positioning seat, and thus, the housing held in position, avoiding slippage during operation.

Preferably, the adhesive tape dispenser further comprises a second tape roller and a second cutter unit. The second tape roller is rotatably mounted at an outer wall of one end of the housing. The second cutter unit comprises a second cutter holder mounted at an outer wall of the other end of the housing at a front side relative to the second tape roller, and a second cutter blade mounted in the second cutter holder. Thus, the user can selectively use the second cutter unit to cut the adhesive tape of the tape roll at different lengths.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of an adhesive tape dispenser in accordance with the present invention.

FIG. 2 is a partial exploded view of the adhesive tape dispenser in accordance with the present invention.

FIG. 3 is a plain view of the rotating wheel according to the present invention.

FIG. 4 is a sectional side view of a part of the present invention, illustrating the engagement arrangement of the gears of the gear set.

FIG. 5 is an exploded view of the present invention, illustrating the structural relationship between the housing and the positioning seat of the positioning unit.

FIG. 6 is a sectional view of a part of the present invention, illustrating a status of the suction cup before pressing of the press bar.

FIG. 7 is similar to FIG. 6, illustrating the press bar pressed on the suction cup.

FIG. 8 is a side view of the present invention, illustrating a status of the adhesive tape dispenser before operation.

FIG. 9 is similar to FIG. 8, illustrating an operation status of the adhesive tape dispenser.

### DETAILED DESCRIPTION OF THE INVENTION

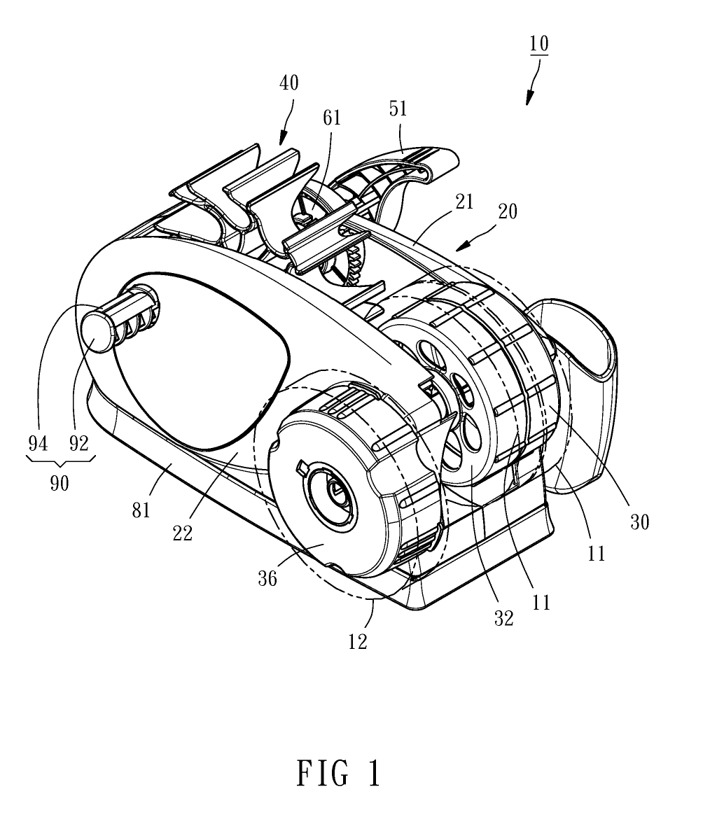

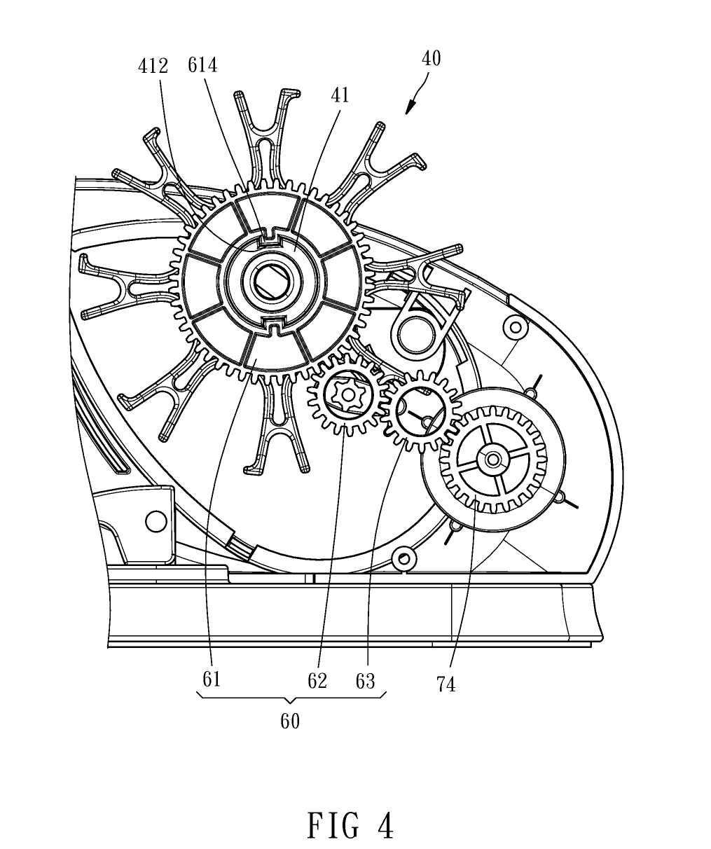

Referring to FIGS. 1, 2, 4 and 5, an adhesive tape dispenser 10 in accordance with the present invention is shown. The adhesive tape dispenser 1 comprises a housing 20, two first tape rollers 30; 32, a rotating wheel 40, an operating handle 50, a gear set 60, a first cutter unit 70, and a positioning unit 80.

The housing 20 comprises a first side cover 21 and a second side cover 22. The first side cover 21 and second side cover 22 each comprise two first hooked rods 23 located at a bottom wall thereof, and a rectangular opening 24 abutted against each other.

The first tape roller 30 is rotatably mounted between the first side cover 21 and second side cover 22 of the housing 20 by a first axle 34 for supporting a tape roll 11. The first tape roller 32 is mounted on the first axle 34 in a parallel manner relative to the first tape roller 30 for supporting another tape roll 11. Actually, the first tape roller 32 can be omitted according to actual needs.

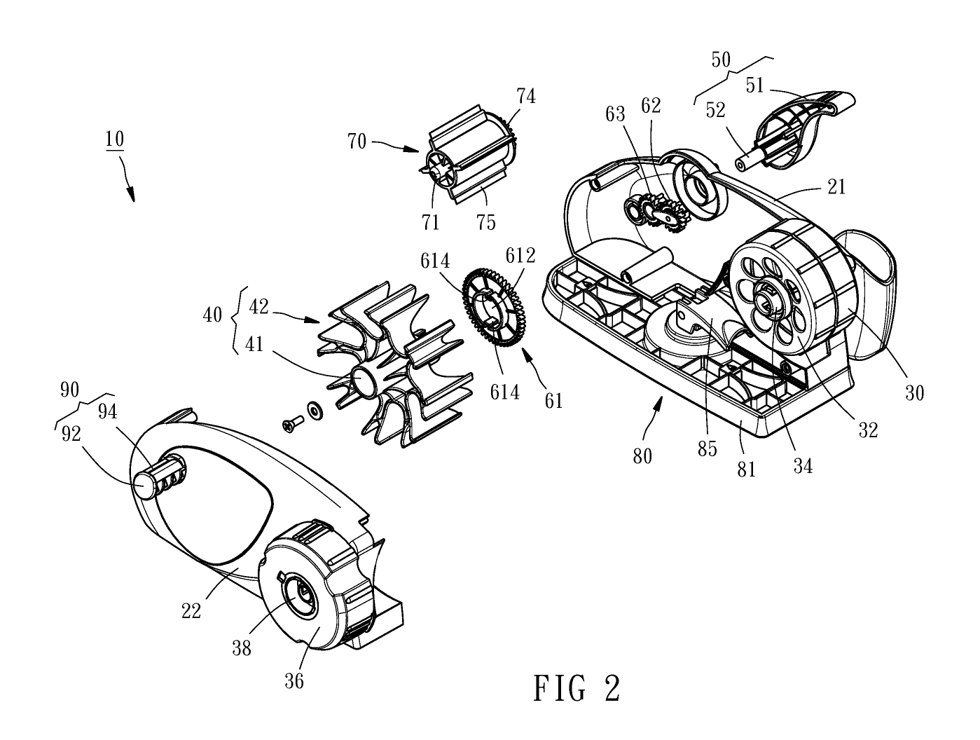

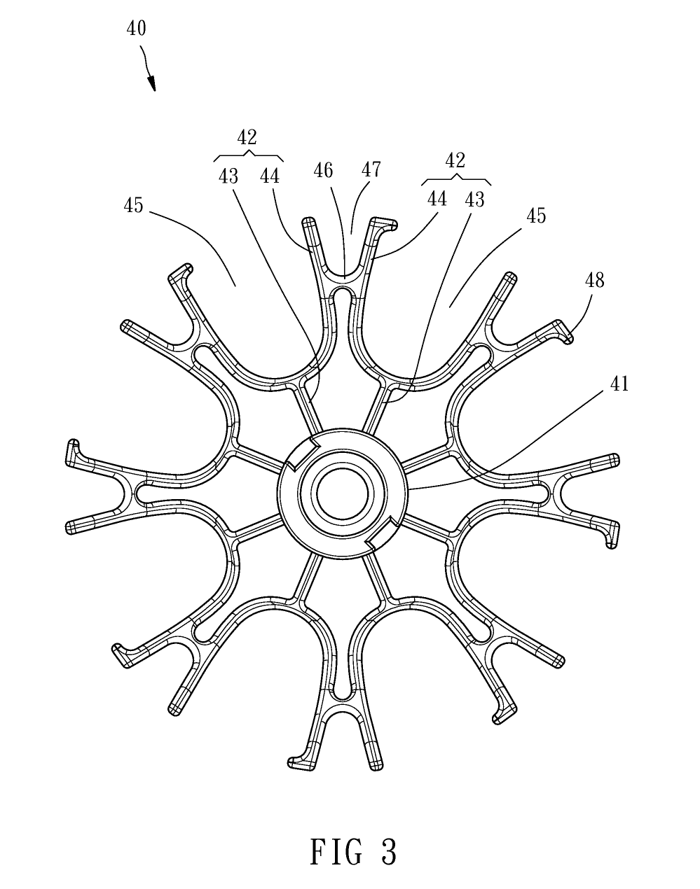

Referring to FIGS. 2 and 3, the rotating wheel 40 is disposed in a front side relative to the first tape rollers 30; 32, comprising a rotating shaft 41 and a plurality of supporting arms 42. The rotating shaft 41 is rotatably mounted between the first side cover 21 and second side cover 22 of the housing 20, comprising two opposing recessed portions 412 located in the outer peripheral surface of one end thereof. The supporting arms 42 are radially arranged about the rotating shaft 41, each comprising a supporting portion 43 and an arched portion 44. The supporting portion 43 is connected between the arched portion 44 and the rotating shaft 41. The direction of the open side of the arched portion 44 is opposite to the rotating shaft 41, thus, the arched portion 44 defines therein a finger slot 45 for the insertion of a finger. Further, the arched portions 44 of each two adjacent supporting arms 42 are connected together by a connection portion 46, and thus, a cutting slot 47 is defined by each two adjacent arched portions 44 and the associating connection portion 46. The width of the cutting slots 47 is smaller than the width of the finger slots 45. Each supporting arm 42 further comprises a flange 48 transversely extended from one end of the arched portion 44 thereof toward the opposite end of the arched portion 44.

As illustrated in FIG. 2, the operating handle 50 comprises a handle grip 51 and a handle grip 51 and a handle shaft 52. The handle shaft 52 is rotatably inserted through the first side cover 21 of the housing 20, having one end thereof connected to the rotating shaft 41 of the rotating wheel 40 by a one-way bearing 53 and an opposite end thereof extended out of the housing 20 and connected with the handle grip 51. Thus, pressing down the handle grip 51 will cause the handle shaft 52 to rotate the rotating wheel 40; turning the handle grip 51 upwards will cause the one-way bearing 53 to release the interlocking relationship between the handle shaft 52 and the rotating wheel 40, i.e., the rotating wheel 40 will not be rotated with the handle shaft 52 in the reversed direction.

The gear set 60 comprises a drive gear 61, and two transmission gears 62; 63 (actually one transmission gear can achieve the same effect). As shown in FIGS. 2 and 3, the drive gear 61 comprises a coupling hole 612 coupled to the rotating shaft 41 of the rotating wheel 40, and two engagement ribs 614 located in the coupling hole 612 at two opposite sides and respectively engaged into the recessed portions 412 of the rotating shaft 41. The two transmission gears 62; 63 are rotatably mounted on an inner wall of the first side cover 21 of the housing 20 and meshed together. One transmission gear 62 is also meshed with the drive gear 61. Thus, the drive gear 61 is rotatable with the rotating wheel 40 to rotate the two transmission gears 62; 63 synchronously.

The first cutter unit 70 comprises a first cutter holder 71, a driven gear 74, and four first cutter blades 75. The first cutter holder 71 is a cylindrical member having two opposite ends thereof rotatably connected between the first side cover 21 and second side cover 22 of the housing 20. The driven gear 74 is fixedly mounted on one end of the first cutter holder 71 and meshed with one transmission gear 63. The first cutter blades 75 are equiangularly arranged around the outer perimeter of the first cutter holder 71. Thus, the driven gear 74 can be driven by the transmission gear 63 to rotate the first cutter holder 71, causing the first cutter blades 75 to be synchronously rotated with the first cutter holder 71.

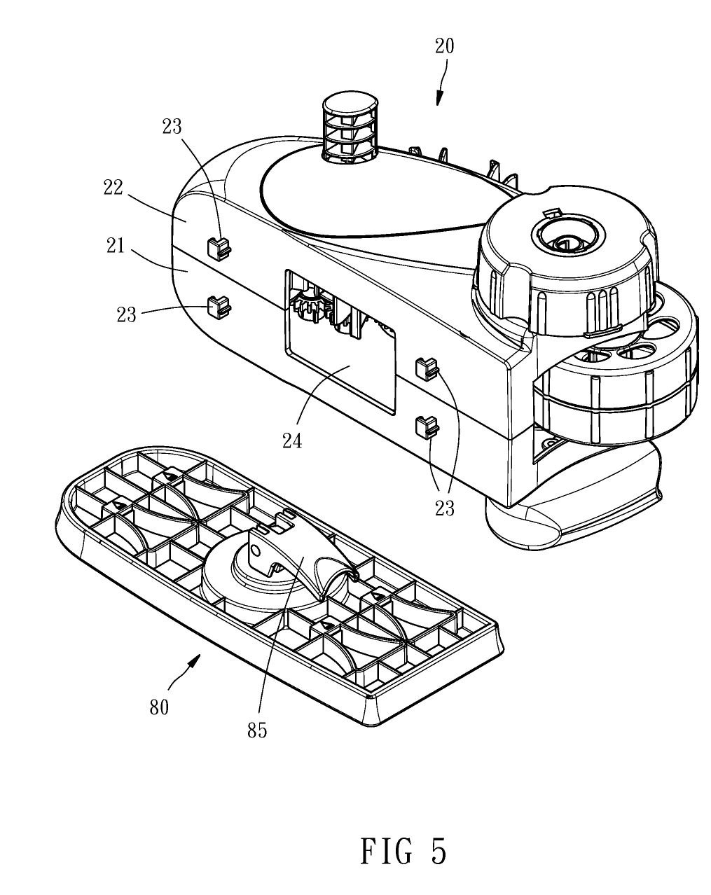

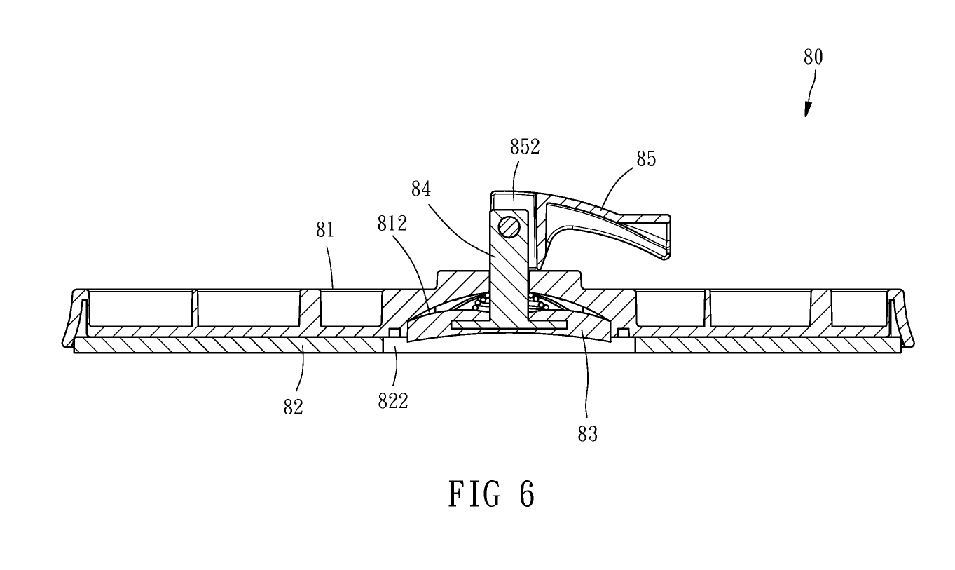

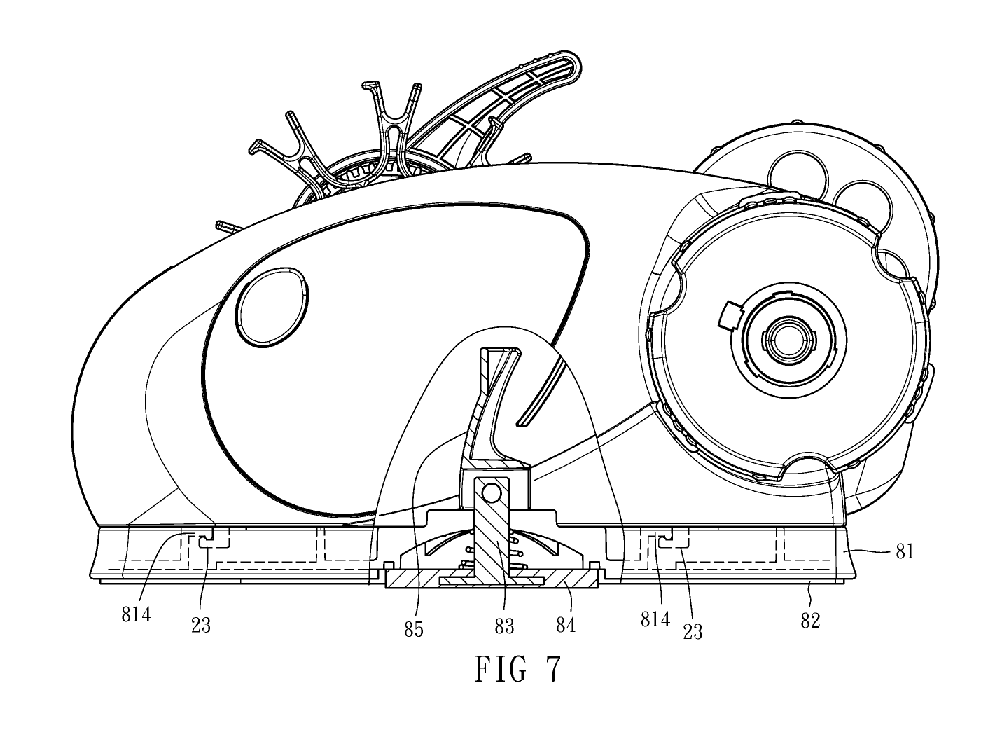

Referring to FIGS. 5-7, the positioning unit 80 comprises a positioning seat 81. The positioning seat 81 comprises an accommodation chamber 812 located at the center thereof, and two pairs of second hooked rods 814 extended from a top wall thereof. The positioning unit 80 further comprises an anti-slip pad 82, a suction cup 83, a press bar 84, and an operating rod 85. The anti-slip pad 82 is mounted on an opposing bottom wall of the positioning seat 81, comprising an opening 822 cut through opposing top and bottom walls thereof and disposed in communication with the accommodation chamber 812. The suction cup 83 is accommodated in the accommodation chamber 812 of the positioning seat 81 and the opening 822 of the anti-slip pad 82. The press bar 84 has a top end thereof inserted into the inside of the housing 20 and an opposing bottom end thereof inserted into the accommodation chamber 812 of the positioning seat 81 and fixedly connected with the suction cup 83. The operating rod 85 has a cam portion 852 located at one end thereof and pivotally connected to the top end of the press bar 84. Thus, the press bar 84 can be driven by the operating rod 85 to move the suction cup 83.

Before tape dispensing, the user can operate the operating rod 85 to secure the suction cup 83 to a tabletop (not shown), and then hook up the first hooked rods 23 of the first side cover 21 and second side cover 22 of the housing 20 with the respective second hooked rods 814 of the positioning seat 81, enabling the housing 20 to be positively and steadily positioned on the tabletop. After installation, the operating rod 85 extends through the rectangular opening 24 into the inside of the housing 20. At this time, the user can start to dispense the adhesive tape 112 of the tape roll 11.

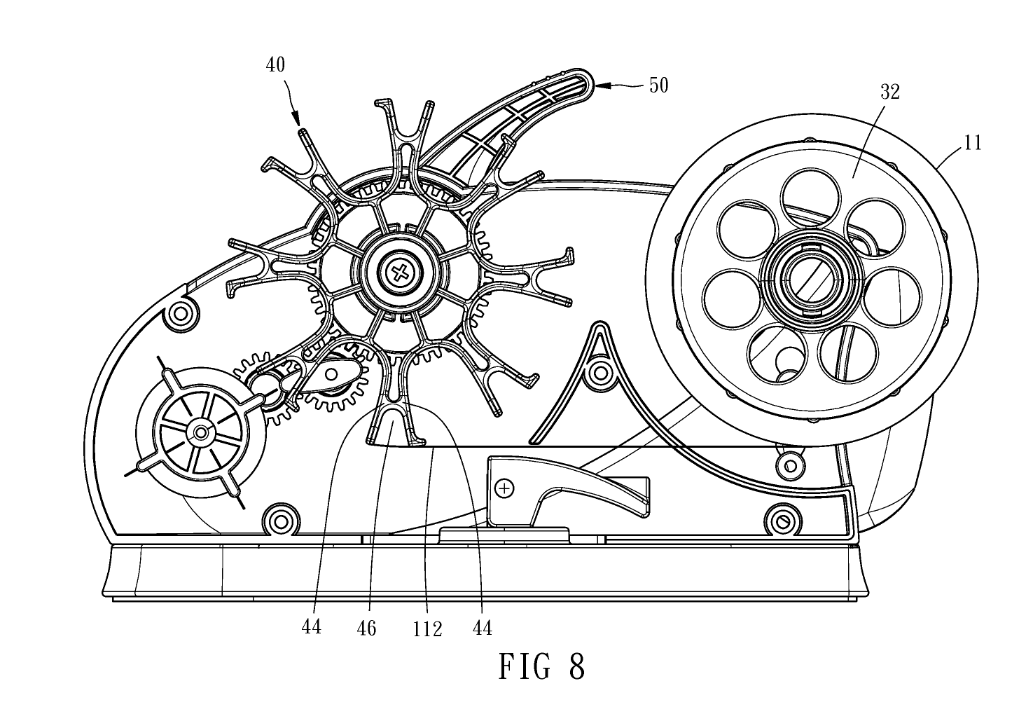

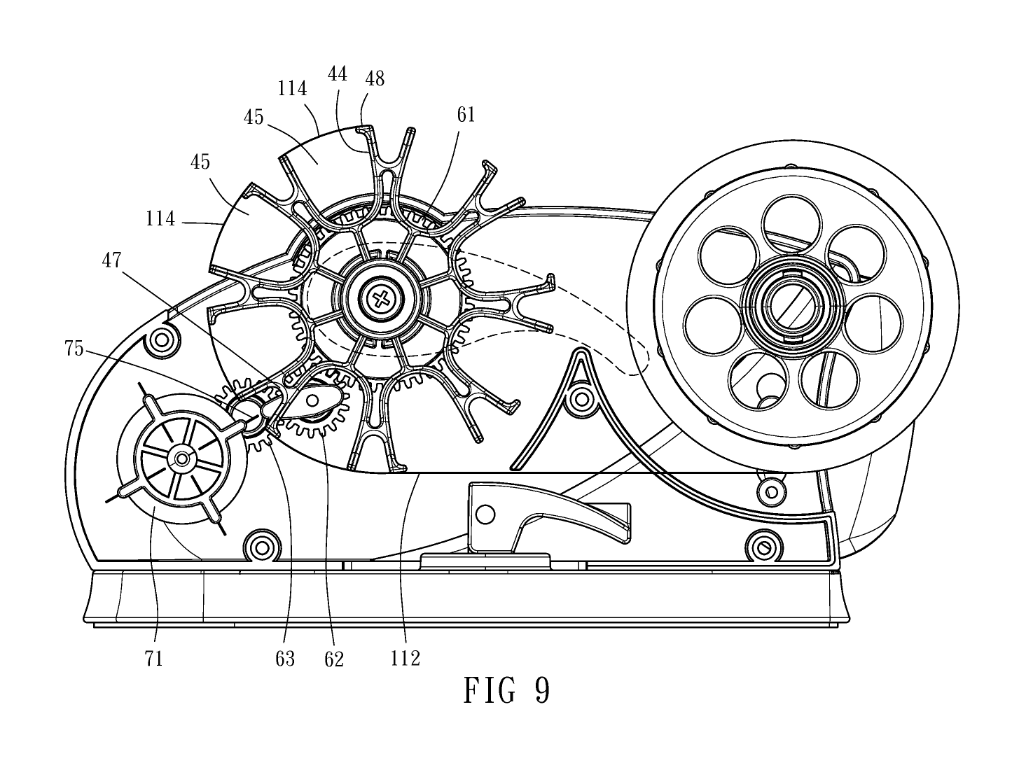

In actual operation, as shown in FIGS. 8 and 9, press down the operating handle 50 to rotate the rotating wheel 40. During rotation of the rotating wheel 40, the arched portions 44 of two adjacent supporting arms 42 of the rotating wheel 40 synchronously pull the adhesive tape 112 of the tape roll 11, at the same time, the rotating shaft 41 of the rotating wheel 40 drives the drive gear 61 to rotate the two transmission gears 62; 63, causing the driven gear 74 to rotate the first cutter holder 71. During rotation of the first cutter holder 71, the first cutter blades 75 will be sequentially inserted into one respective cutting slot 47 of the rotating wheel 40 to cut the adhesive tape 112 into multiple adhesive tape segments 114 of the same length. After cutting, every piece of adhesive tape segment 114 will be adhered to one respective supporting arm 42 between the two opposite ends of the associating arched portion 44. At this time, the flanges 48 of the supporting arms 42 provide a large adhesive surface area for the adhesion of the adhesive tape segments 114, avoiding falling of adhesive tape segments 114 from the rotating wheel 40. After a predetermined number of adhesive tape segments 114 has been cut from the adhesive tape 112, the user can turn the operating handle 50 upwards to release the interlocking relationship between the operating handle 50 and the rotating wheel 40, stopping the rotating wheel 40 and the first cutter holder 71 from rotation. At last, the user can insert one finger into each finger slot 45 to pick up the respective adhesive tape segment 114 from the rotating wheel 40.

On the other hand, in order to meet different user needs, the adhesive tape dispenser 10 further provides a second tape roller 36 and a second cutter unit 90. The second tape roller 36 is mounted at an outer wall of the second side cover 22 of the housing 20 by a second axle 38 for supporting a tape roll 12. The second cutter unit 90 comprises a second cutter holder 92, and a second cutter blade 94 mounted at the second cutter holder 92. The second cutter holder 92 is mounted at the outer wall of the second side cover 22 at a front side relative to the second tape roller 36. Thus, the user can operate the adhesive tape dispenser 10 according to the above-described operating procedure to cut the adhesive tape 112 into multiple pieces of adhesive tape segments 114 of the same length, and can also selectively use the second cutter blade 94 of the second cutter unit 90 to cut the adhesive tape of the tape roll 12 at different lengths.

In conclusion, subject to matching between the rotating wheel 40 and first cutter unit 70, the adhesive tape dispenser 10 is operable to rapidly pulled out the adhesive tape 112 by the rotating wheel 40 and to simultaneously cut the adhesive tape 112 into multiple adhesive tape segments 114 of the same length, and thus the efficiency of the cutting operation is greatly improved. Further, the design of the suction cup 83 of the positioning unit 80 enables the housing 20 to be positively and steadily positioned on the tabletop prior to the cutting operation, achieving the purpose of increasing the operational stability.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An adhesive tape dispenser capable of cutting a uniform length of adhesive tape, comprising:
a housing;
a first tape roller rotatably mounted in one end of said housing;
a rotating wheel comprising a rotating shaft rotatably mounted in an opposite end of said housing, a plurality of supporting arms radially connected to and equiangularly space around the periphery of said rotating shaft, and a cutting slot defined between each two adjacent said supporting arms;
an operating handle comprising a handle grip and a handle shaft, said handle shaft having one end thereof rotatably inserted through one lateral side of said housing and connected to said rotating shaft of said rotating wheel and an opposite end thereof extended out of said housing and connected with said handle grip;
a gear set comprising a drive gear coupled to said rotating shaft of said rotating wheel and at least one transmission gear rotatably mounted inside said housing and meshed with said drive gear;
a first cutter unit comprising a first cutter holder rotatably mounted inside said housing, a driven gear fixedly mounted on one end of said first cutter holder and meshed with said at least one transmission gear of said gear set, and a plurality of first cutter blades equiangularly arranged around the periphery of said first cutter holder and respectively selectively insertable into one said cutting slot of said rotating wheel.

2. The adhesive tape dispenser capable of cutting an adhesive tape at a uniform length as claimed in claim 1, wherein said positioning unit further comprises a positioning seat, an operating rod and a press bar, said positioning seat being mounted in the bottom side of said housing and defining therein an accommodation chamber, said operating rod being disposed inside said housing and comprising a cam portion, said press bar having a top end thereof pivotally connected to said cam portion of said operating rod and an opposing bottom end thereof inserted into said accommodation chamber and fixedly connected with said suction cup.

3. The adhesive tape dispenser capable of cutting an adhesive tape at a uniform length as claimed in claim 2, wherein said housing comprises at least one first hooked rod located at the bottom side thereof; said positioning seat of said positioning unit comprises at least one second hooked rod located at a top wall thereof and detachably engageable with said at least one first hooked rod of said housing.

4. The adhesive tape dispenser capable of cutting an adhesive tape at a uniform length as claimed in claim 2, wherein said positioning unit further comprises an anti-slip pad mounted at a bottom side of said positioning seat, said anti-slip pad comprising an opening disposed in communication with said accommodation chamber; said suction cup is accommodated in said accommodation chamber and said opening of said anti-slip pad.

5. The adhesive tape dispenser capable of cutting an adhesive tape at a uniform length as claimed in claim 1, wherein each said supporting arm of said rotating wheel comprises a supporting portion and an arched portion, said supporting portion being connected between said arched portion and said rotating shaft, said arched portion defining therein a finger slot, the width of said finger slot being larger than the width of said cutting slot; said rotating wheel further comprises a connection portion connected between the arched portions of each two adjacent said supporting arms and defining with the associating two said arched portions one respective said cutting slot.

6. The adhesive tape dispenser capable of cutting an adhesive tape at a uniform length as claimed in claim 5, wherein each said supporting arm of said rotating wheel comprises a flange transversely extended from one end of the respective said arched portion toward an opposite end thereof.

7. The adhesive tape dispenser capable of cutting an adhesive tape at a uniform length as claimed in claim 1, further comprising a second tape roller and a second cutter unit, said second tape roller being rotatably mounted at an outer wall of one of the two opposing ends of said housing, said second cutter unit comprising a second cutter holder mounted at an outer wall of the other of the two opposing ends of said housing and a second cutter blade mounted in said second cutter holder.

8. The adhesive tape dispenser capable of cutting an adhesive tape at a uniform length as claimed in claim 1, wherein said rotating shaft of said rotating wheel comprises at least one recessed portion located in the periphery thereof; said drive gear comprises a coupling hole coupled to said rotating shaft of said rotating wheel, and at least one engagement rib located in said coupling hole and engaged into said at least one recessed portion of said rotating shaft.

9. The adhesive tape dispenser capable of cutting an adhesive tape at a uniform length as claimed in claim 1, wherein said tape dispenser comprising a positioning unit comprising a suction cup located in a bottom side of said housing.
